(19) United States
(12) Patent Application Publication
(10) Pub. No.: US 2025/0266536 A1
(43) Pub. Date: Aug. 21, 2025

(54) SECONDARY BATTERY

(71) Applicant: SAMSUNG SDI CO., LTD., Yongin-si (KR)

(72) Inventor: Hyun Soo LEE, Yongin-si (KR)

(21) Appl. No.: 18/673,301

(22) Filed: May 23, 2024

(30) Foreign Application Priority Data
Feb. 15, 2024 (KR) 10-2024-0021562

(51) Int. Cl. H01M 50/119; H01M 50/103; H01M 50/15; H01M 50/169; H01M 50/548; H01M 50/553

(52) U.S. Cl. CPC H01M 50/119; H01M 50/103; H01M 50/15; H01M 50/169; H01M 50/548; H01M 50/553

(57) ABSTRACT

The secondary battery according to an embodiment includes an electrode assembly comprising a first electrode plate, a second electrode plate, and a separator interposed between the first electrode plate and the second electrode plate. A can with ends open accommodates the electrode assembly A first side plate seals a first open end of the can and a second side plate seals the second open end of the can. The can comprises a first metal and a second metal formed on an outer surface of the first metal, the first side plate and the second side plate are coupled to the first metal, a thermal conductivity of the first metal is greater than a thermal conductivity of the second metal.

### CROSS-REFERENCE TO THE RELATED APPLICATION

The present application claims priority to and the benefit of Korean Patent Application No. 10-2024-0021562, filed on Feb. 15, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery may be divided into a cylindrical shape, a square shape, or a pouch type (or a polymer type) according to its appearance. A prismatic battery may be formed by embedding an electrode assembly and an electrolyte in a can, and placing a cap plate on the can. The electrode assembly includes a positive electrode plate, a negative electrode plate, and a separator therebetween.

The information disclosed in this section is provided only for enhancement of understanding of the background of the disclosure and therefore it may contain information that does not form the prior art.

### SUMMARY

Embodiments provide a secondary battery capable with improved weldability of its can, and the can is prevented from melting when an event occurs.

The secondary battery according to the embodiment includes an electrode assembly comprising a first electrode plate, a second electrode plate, and a separator interposed between the first electrode plate and the second electrode plate; a can accommodating the electrode assembly, the can being open at a first end and open at a second end that is opposite to the first end; a first side plate for sealing the first end of the can; and a second side plate for sealing the second end of the can, wherein the can comprises a first metal and a second metal formed on an outer surface of the first metal, wherein the first side plate and the second side plate are coupled to the first metal of the first side plate, wherein a thermal conductivity of the first metal is greater than a thermal conductivity of the second metal.

In addition, a thickness of the first metal is greater than or equal to a thickness of the second metal.

In addition, the first metal forms an inner surface of the can and part of an outer surface of the can, the second metal forms a part of the outer surface of the can, an edge of the first metal is thicker than a thickness of the second metal, the outer surface of the first metal has a step part formed by the edge, and the second metal is embedded in the step part.

In addition, a part of the outer surface of the first metal and an outer surface of the second metal are coplanar.

In addition, the step part is a first step part and a second step part is formed on the inner surface of the edge of the first metal.

In addition, the secondary battery includes a first side terminal and a second side terminal, and one of the first side terminal and the second side terminal is coupled to the second step part.

In addition, an area of the first side plate or the second side plate coupled to the second step part comprises a chamfer region.

In addition, a diameter of the first side plate or a diameter of the second side plate is reduced by the chamfer region.

In addition, a protrusion is formed on the inner surface of the can, and the protrusion supports a surface of the first side plate or a surface of the second side plate.

In addition, a groove corresponding to the protrusion is formed on the outer surface of the can.

In addition, the protrusion comprises a plurality of protrusions spaced apart from each other.

In addition, the can is formed in a pipe shape or in a bent plate shape.

In addition, a melting point of the second metal is greater than a melting point of the first metal.

In addition, the first metal and the second metal comprise different metals.

In addition, the groove is formed in the first metal.

In addition, an area of the second metal forming part of the outer surface of the can is greater than an area of the first metal forming part of the outer surface of the can.

In addition, an area of the first or second side plate coupled to the protrusion comprises a chamfer region.

In addition, the protrusion is formed at the edge of the first metal.

In addition, a thickness of the first side plate or the second side plate is less than a length of the edge of the first metal.

In addition, the can is formed by coupling two rectangular tubes.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view of a secondary battery according to an embodiment.

FIG. 2 is a side view of the secondary battery according to the embodiment.

FIG. 3 is another side view of the secondary battery according to the embodiment.

FIG. 4 is a bottom view of the secondary battery according to the embodiment.

FIG. 5 is a sectional view of the secondary battery

according to the embodiment.

FIG. 6 is a sectional view of a base material of a case of the secondary battery according to the embodiment.

FIG. 7 is an enlarged view of a coupling section of a side plate and a can of the secondary battery according to the embodiment.

FIG. 8 is a perspective view of an electrode assembly of the secondary battery according to the embodiment.

FIG. 9 is a perspective view of a can of the secondary battery according to the embodiment.

FIG. 10 is a perspective view of a secondary battery according to another embodiment.

FIG. 11a is a partial perspective view of the secondary battery according to another embodiment.

FIG. 11b is a perspective view of a can of the secondary battery according to another embodiment.

FIG. 12 an enlarged view of a coupling section of a side plate and a can of the secondary battery according to another embodiment.

FIG. 13 is a partial perspective view of the secondary battery according to another embodiment.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to an embodiment will be described with reference to the drawings.

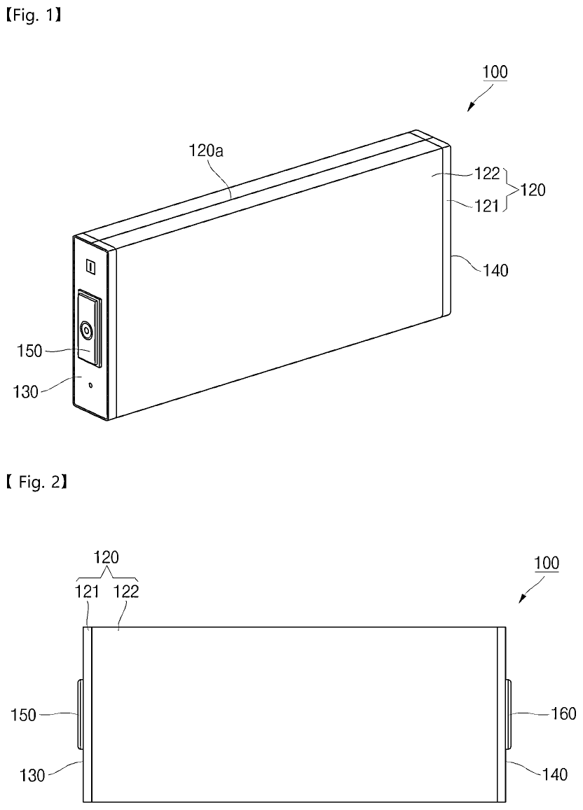

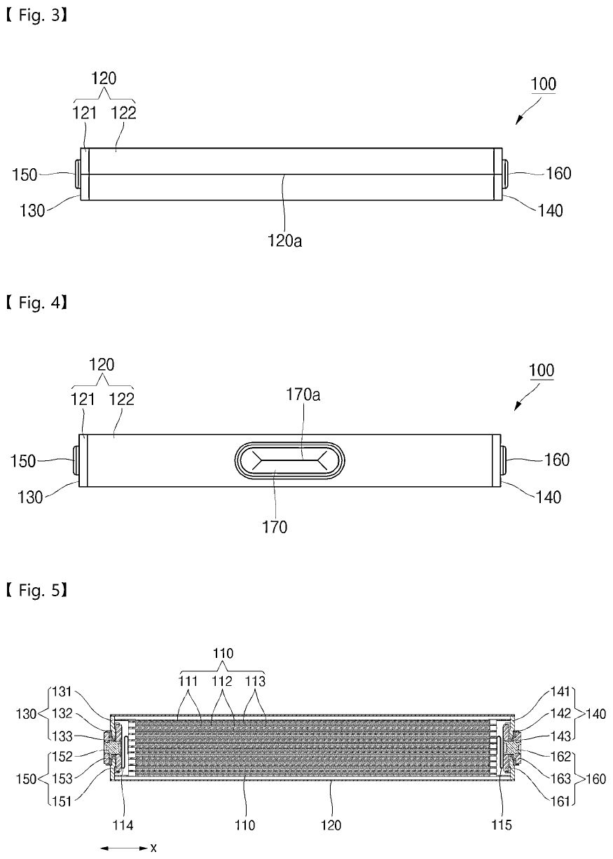

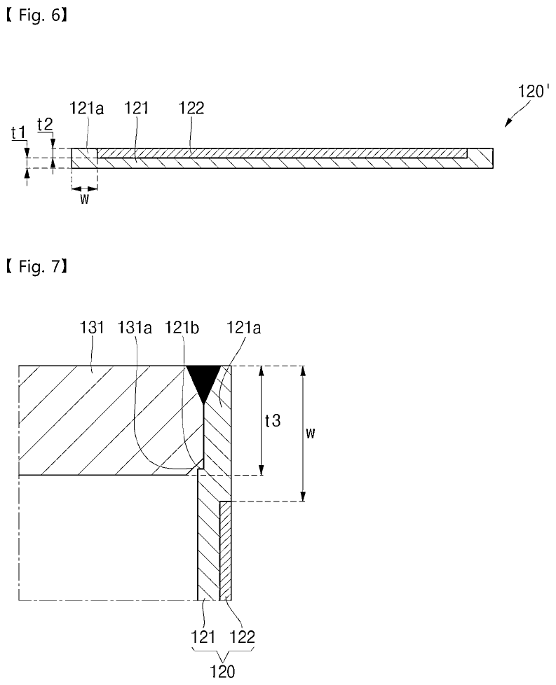

FIG. 1 is a perspective view of a secondary battery according to an embodiment. FIGS. 2 and 3 is a side views of the secondary battery according to the embodiment. FIG. 4 is a bottom view of the secondary battery according to the embodiment. FIG. 5 is a sectional view of the secondary battery according to the embodiment.

Referring to FIGS. 1 to 5, the secondary battery 100 according to an embodiment may include an electrode assembly 110, a can 120, a first side plate 130, a second side plate 140, a first side terminal 150, and a second side terminal 160. The electrode assembly 110 is disposed in the can 120. Thus, the electrode assembly 110 is not shown in FIGS. 1-4.

The electrode assembly 110 may include a first electrode plate 111, a second electrode plate 112, and a separator 113.

The first electrode plate 111 may be a negative electrode plate. The first electrode plate 111 may include a conductive metal thin plate. For example, the first electrode plate 111 may include a negative electrode current collector plate and a negative electrode active material coated on the negative electrode current collector plate. The negative electrode current collector plate may include copper or nickel (foil or mesh). The first electrode plate 111 may include a negative electrode coating portion coated with the negative electrode active material and a negative electrode uncoated portion not coated with the negative electrode active material. The negative electrode active material may include a carbon-based material, Si, Sn, tin oxide, tin alloy composite, a transition metal oxide, lithium metal nitride, or a metal oxide.

The second electrode plate 112 may be a positive electrode plate. The second electrode plate 112 may include a conductive metal thin plate. For example, the second electrode plate 112 may include a positive electrode current collector plate and a positive electrode active material coated on the positive electrode current collector plate. The positive electrode current collector plate may include aluminum (foil or mesh). The second electrode plate 112 may include a positive electrode coating portion coated with a positive electrode active material and a positive electrode uncoated portion not coated with the positive electrode active material. The positive electrode active material may include a chalcogenide compound. For example, the positive electrode active material may include a composite metal oxide such as LiCoO₂, LiMn₂O₄, LiNiO₂, and LiNiMnO₂.

The separator 113 may be interposed between the first electrode plate 111 and the second electrode plate 112. The first electrode plate 111 and the second electrode plate 112 may be prevented from being electrically short-circuited by the separator 113. The separator 113 may include a porous polymer such as polyethylene, polypropylene, or polyethylene and polypropylene.

The can 120 may accommodate the electrode assembly 111 together with an electrolyte. The can 120 may include two plate-shaped members including a bent portion. The corners of the plate-shaped members may face each other by the bent portion. The can 120 is formed by welding the corner 120a. Accordingly, the can 120 may have a shape in which a space is formed therein and both ends are opened. A first side plate 130 and a second side plate 140 may be coupled to the ends of the can 120. Accordingly, both ends of the can 120 may be sealed.

A safety vent 170 may be formed on one surface of the can 120. When gas is generated inside the can 120, pressure may increase inside of the can 120 as a result of the gas. The safety vent 170 may be punctured as a result of the increased pressure to thereby discharge gas. Accordingly, it is possible to prevent the secondary battery 100 from exploding. The safety vent 170 may include a notch 170a that facilitates the puncture. The safety vent 170 may be fixed by overlap welding.

The can 120 may include a plurality of metals. For example, the can 120 may include a first metal 121 and a second metal 122. The first metal 121 may be disposed in the inner and outer surface of the can 120. The first metal 121 may include a metal having high thermal conductivity. The second metal 122 may be disposed in the outer surface of the can 120. The second metal 121 may include a metal having a high melting temperature. For example, the first metal 121 may include aluminum. The second metal 122 may include stainless steel. The multi-layered metal may be called a clad. The can may maintain high thermal conductivity on the inner surface thereof and prevent melting on the outer surface thereof by the multi-layered metal. Accordingly, weldability between the can 120 and the side plates 130 and 140 may be improved by the first metal 121. Also, when an event occurs in the can 120, the can 120 may not melt because of the second metal 122. The structure and welding coupling of the can 120 will be described below.

The first side plate 130 may be formed in a square plate shape corresponding to the open end of the can 120. The first side plate 130 may be welded to one end of the can 120 to seal the can 120.

The first side plate 130 may include a first cap plate 131, a first coupling member 132, and a first sealing gasket 133. The first cap plate 131 may have a flat square plate shape. The first cap plate 131 may seal the left opening 121 of the can 120.

The first coupling member 132 and the first seal gasket 133 may be disposed between the outer surface of the first cap plate 131 and the first side terminal 150. The first coupling member 132 may be in close contact with the first cap plate 131. The first coupling member 132 may be in close contact with the first seal gasket 133. The first coupling member 132 and the first seal gasket 133 may include an insulating material. The first cap plate 131 and the first side terminal 150 may be insulated from each other by the first coupling member 132 and the first seal gasket 133.

The second side plate 140 may be formed in a square plate shape corresponding to the open other end of the can 120. The other end is opposite to the one end. The second side plate 140 may be welded to the other end of the can 120 to seal the can 120.

The second side plate 140 may include a second cap plate 141, a second coupling member 142, and a second seal gasket 143. The configurations are similar to those of the first side plate 140.

The first side terminal 150 is electrically connected to the uncoated portion (negative electrode uncoated portion) of the first electrode plate 111, and is exposed to outside of the battery 100 through the first side plate 130. Thus, the first side terminal 150 may be a negative electrode terminal. The first side terminal 150 may include a first inner plate 151, a first terminal post 152, and a first outer plate 153.

The first side terminal 150 may include metal. The first side terminal 150 may be electrically connected to a first electrode tab 114.

The first inner plate 151 may be located on an inner side of the first cap plate 131. The first outer plate 153 may be located on an outer side of the first cap plate 131. The first coupling member 132 may be disposed between the first outer plate 153 and the first cap plate 131. The first sealing gasket 133 may be disposed between the first terminal post 152 and the first cap plate 131. The first sealing gasket 133 may be disposed between the first inner plate 151 and the first cap plate 131. The first terminal post 152 penetrates the first cap plate 131. Accordingly, the first terminal post 152 may be coupled to the first outer plate 153 on an outer side of the first cap plate 131. Also, the first terminal post 152 may be coupled to the first inner plate 151 on an inner side of the first cap plate 131. The first inner plate 151 may be welded and coupled to the first electrode tab 114 from the inside thereof.

The first terminal post 152 may be inserted and coupled through the first inner plate 151. For example, the first terminal post 152 may be riveted and/or welded from one surface thereof in a state of being inserted into the terminal hole of the first inner plate 151. The first terminal post 152 may have a pillar shape protruding and extending to the outwardly from the first cap plate 131.

The first outer plate 153 may include a terminal hole penetrating through the first outer plate 153 between opposite surfaces. The first terminal post 152 may pass through the terminal hole of the first outer plate 153 to be riveted and/or welded.

The second side terminal 160 may be electrically connected to the uncoated portion (positive electrode uncoated portion) of the second electrode plate 112. The second side terminal 160 may be exposed to outside of the battery 100 through the second side plate 140. Thus, the second side terminal 160 may be a positive terminal. An insulating member may be disposed between the second side terminal 160 and the second side plate 140 to prevent an electrical short circuit.

The second side terminal 160 may include a second inner plate 161, a second terminal post 162, and a second outer plate 163. A structure of the second side terminal 160 is similar to that of the first side terminal 150.

Hereinafter, the structure and coupling of the can 120 of the secondary battery 100 according to the embodiment will be described in detail.

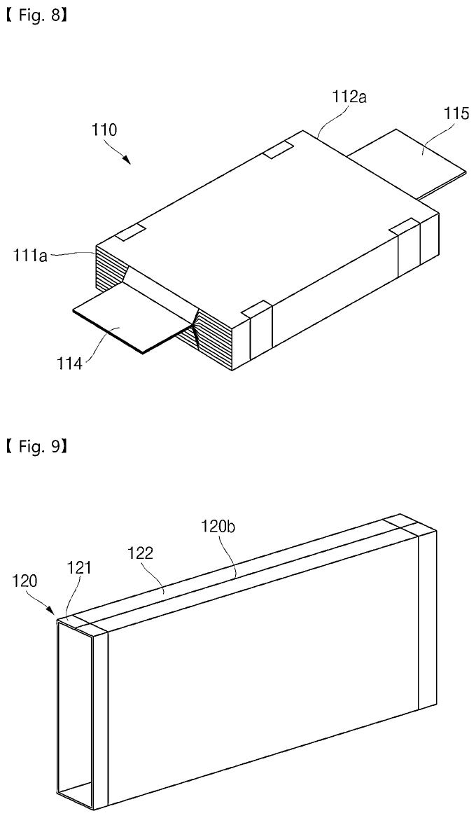

FIG. 6 is a sectional view of a base material of a can of the secondary battery according to the embodiment. FIG. 7 is an enlarged view of a coupling section of a side plate and a can of the secondary battery according to the embodiment. FIG. 8 is a perspective view of an electrode assembly of the secondary battery according to the embodiment. FIG. 9 is a perspective view of a can of the secondary battery according to the embodiment.

Referring to FIG. 6, the can 120 may be formed using a base material 120′. The base material 120′ may include a first metal 121 and a second metal 122. The second metal 122 may be coupled to an outer surface of the first metal 121. The second metal 122 may be surrounded by the edge 121a of the first metal 121. In detail, the edge 121a of the first metal 121 may be formed to a set length w. The second metal 122 may be disposed in the inner region (first step part) formed by the edge 121a. Accordingly, the second metal 122 may be embedded in the first metal 121. However, embodiments are not limited thereto. The second metal 122 may be disposed such that a surface of the second metal 122 is coplanar with the edge 121a. In detail, the first metal 121 may have a first thickness t1. The edge 121a may protrude to a second thickness t2. The second metal 122 may also have the second thickness t2. Accordingly, when viewed from its side, the base material 120′ may have a flat plate shape.

Also, the first thickness t1 may be greater than or equal to the thickness of the second metal. Accordingly, the thermal conductivity of the can 120 may be increased by the first metal 121.

Referring to FIG. 7, a stepped portion 121b may be formed by processing the base material 120′. The first side plate 130 may be coupled in a state of being supported by the stepped portion 121b. In detail, the inner diameter of the base material 120 may be reduced by the stepped portion 121b. Accordingly, the first cap plate 131 of the first side plate 130 may be supported by the stepped portion 121b. Subsequently, welding may be performed along the boundary between the first cap plate 131 of the first site plate 130 and the first metal 121. Accordingly, the first side plate 130 may be fixed to the can 120. In addition, the first side plate 130 may seal an end of the can 120.

To this end, a thickness t3 of the first cap plate 131 of the first side plate 130 may be greater than a depth from the end portion of the first side plate 130 to the stepped portion 121b. A chamfer region 131a may be formed at an inner end portion of the first side plate 130. Accordingly, the coupling force between the first side plate 130 and the can 120 may be increased. The length w of the first metal 121 may be longer than the thickness t3 of the first side plate 130. Accordingly, when the first side plate 130 is coupled, it is possible to prevent a pressure due to coupling from being applied to the second metal 122. Accordingly, the position of the second metal 122 may be maintained in a fixed state, and deformation of the can 120 may be prevent.

As described above, the secondary battery 100 according to the embodiment may include a can 120 including a first metal 121 and a second metal 122. The second metal 122 may be disposed on the outer surface of the first metal 121. Accordingly, weldability between the can and the side plates 131 and 132 may be increased by the first metal 121. Also, the can 120 is not melted at a high temperature due to the second metal 122, and thus stability of the battery 100 may be improved.

Hereinafter, the coupling relationship between the electrode assembly and the can will be described in detail.

Referring to FIG. 8, the electrode assembly 110 may include a first electrode tab 114 and a second electrode tab 115. The first electrode tab 114 may be a current collecting tab formed by an extension of the uncoated portion 111a of the first electrode plate. The second electrode tab 115 may be a current collecting tab formed by an extension of the uncoated portion 112a of the second electrode plate. However, the embodiment is not limited thereto. The first electrode tab 114 and the second electrode tab 115 may be separate tabs coupled to the uncoated portions 111a and 112a. The first electrode tab 114 and the second electrode tab 115 may protrude from opposite sides of the electrode assembly 110.

Referring to FIG. 9, the can 120 may have a rectangular parallelepiped shape which is open at both sides. In detail, the can 120 may have the shape of a rectangular tube. The can 120 may be formed by processing the base material 120′. In detail, the base material 120′ may be bent a plurality of times. Accordingly, a rectangular tube shape as shown in FIG. 9 may be formed. Accordingly, the can 120 may have a boundary line 120b with ends facing each other. Also, the second metals 122 formed on the outer surface may contact at the boundary line 120b. Also, the first metals 121 positioned at the edges may contact each other. By welding along the boundary line 120b, a side surface of the can 120 may be sealed.

The electrode assembly 110 may be inserted through both opening portions of the can 120. Subsequently, the side plates 130 and 140 may be coupled to the can 120 to seal the can 120.

Hereinafter, a secondary battery according to another embodiment will be described.

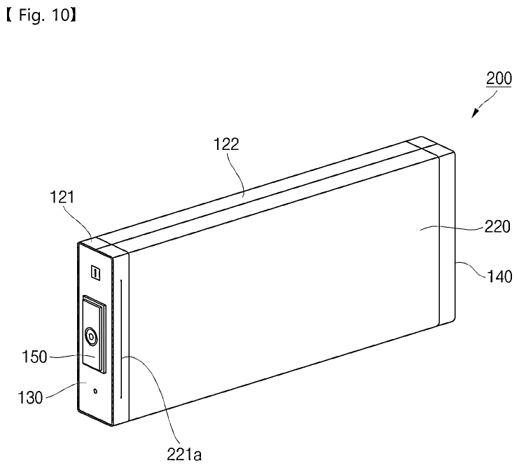

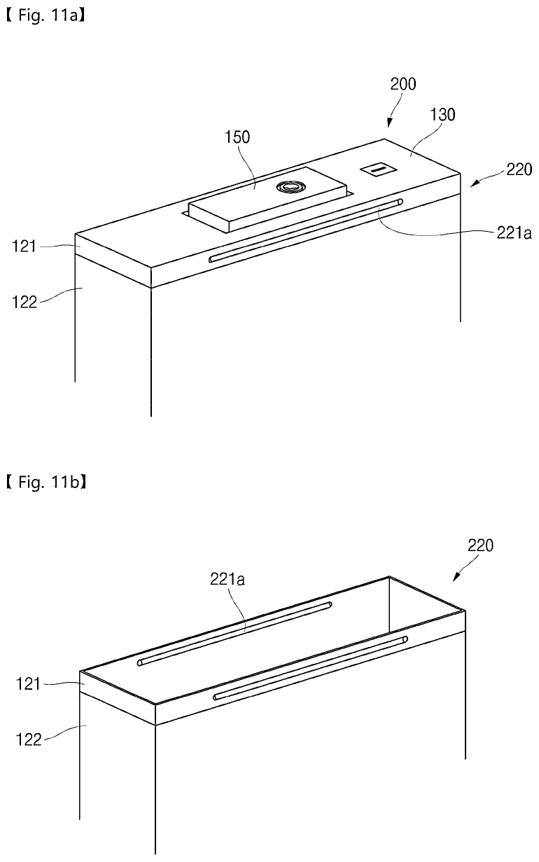

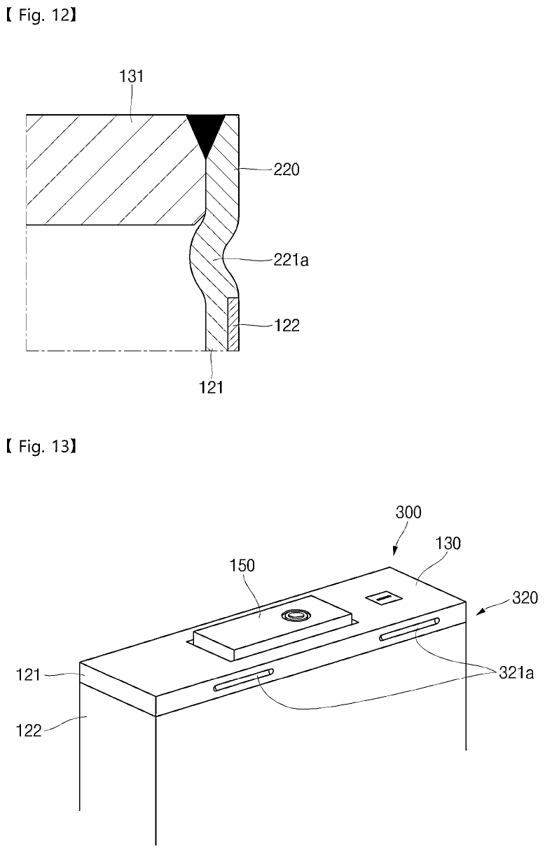

FIG. 10 is a perspective view of a secondary battery according to another embodiment. FIG. 11a is a partial perspective view of the secondary battery according to another embodiment. FIG. 11b is a perspective view of a can of the secondary battery according to another embodiment. FIG. 12 an enlarged view of a coupling section of a side plate and a can of the secondary battery according to another embodiment.

Referring to FIGS. 10 to 12, the secondary battery 200 according to another embodiment may include the electrode assembly, the can 220, the first side plate 130, the second side plate 140, the first side terminal 150, and the second side terminal (not shown in FIGS. 10 to 12). The same reference numerals are assigned to the same elements as those of the previous embodiment. Hereinafter, differences from the previous embodiment will be mainly described.

The can 220 may include the first metal 121 and the second metal 122. The can 220 may include a protrusion 221a. The protrusion 221a may protrude inward from at least one side adjacent to the side plates 130 and 140. The protrusion 221a may be formed through a plastic process such as pressing in a direction from outside to the inside of the can 220. The protrusion 221a may correspond to the step part 121b (second step part) of the previous embodiment. That is, when the can 120 is processed, a separate step part 121b is not formed. Instead, the protrusion 221a may be formed by applying an external force such as pressing from outside of the can 220. Thus, the protrusion 221a may be formed in a simpler manner than the step part 121b. Subsequently, the side plates 130 and 140 may be supported by the protrusions 221a at opposite ends of the battery 200.

Referring to FIG. 12, the first side plate 130 may be welded while being supported by the protrusion 221a. The can 220 does not include separate stepped portion. Therefore, the upper end thickness of the can 220 may be ensured with a desired size. Thus, welding becomes easy, and desired welding strength may be ensured.

Hereinafter, a secondary battery according to another embodiment will be described.

FIG. 13 is a partial perspective view of the secondary battery according to another embodiment.

Referring to FIG. 13, the secondary battery 300 according to another embodiment includes the electrode assembly, a can 320, the first side plate 130, the second side plate (not shown in FIG. 13), the first side terminal 150, and the second side terminal (not shown in FIG. 13). The same reference numerals are assigned to the same elements as those of the previous embodiment. Hereinafter, differences from the previous embodiment will be mainly described.

The can 320 may include the first metal 121 and the second metal 122. The can 320 may include a plurality of protrusions 321a. The protrusions 321a may protrude inward from at least one side adjacent to the side plates 130 and 140.

The protrusions 321a may be formed through plastic processing such as pressing from outside to the inside of the can 320. The protrusions 321a may correspond to the protrusion 221a of the previous embodiment. However, in this case there are a plurality of the protrusions 321a on each side at each end of the battery 300. An external force such as pressing may be applied to a plurality of regions of the can 320 to thereby form the protrusions 321a. Accordingly, the protrusions 321a may be formed by a simple method. Subsequently, the side plates 130 and 140 may be supported by the protrusions 321a.

The protrusions 321a may be formed in a minimum region of the can 320 to support the side plates 130 and 140. Accordingly, welding strength may be improved. Also, the strength of the can 320 may be maintained as much as possible.

The secondary battery according to the embodiment may include a can including a plurality of metals. Accordingly, weldability between the can and the side plate may be improved. In addition, when an event occurs in the can, it is possible to prevent the can from melting.

Also, the secondary battery according to the embodiment may include a can including a protrusion. The protrusion may be formed by modifying the shape of the can above. The side plate above may be fixed by the protrusion. Accordingly, the can may be easily manufactured. In addition, weldability between the can and the side plate may be improved.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. A secondary battery comprising:
an electrode assembly including a first electrode plate, a second electrode plate, and a separator interposed between the first electrode plate and the second electrode plate;
a can accommodating the electrode assembly, the can being open at a first end and open a second end that is opposite to the first end;
a first side plate sealing the first end of the can; and
a second side plate sealing the second end of the can,
wherein the can comprises a first metal and a second metal formed on an outer surface of the first metal,
wherein the first side plate and the second side plate are coupled to the first metal of the first side plate, and
wherein a thermal conductivity of the first metal is greater than a thermal conductivity of the second metal.

2. The secondary battery as recited in claim 1, wherein a thickness of the first metal is greater than or equal to a thickness of the second metal.

3. The secondary battery as recited in claim 1, wherein the first metal forms an inner surface of the can and part of an outer surface of the can,
wherein the second metal forms a part of the outer surface of the can,
wherein an edge of the first metal is thicker than a thickness of the second metal,
wherein an outer surface of the first metal has a step part formed by the edge, and
wherein the second metal is embedded in the step part.

4. The secondary battery as recited in claim 1, wherein a part of the outer surface of the first metal and an outer surface of the second metal are coplanar.

5. The secondary battery as recited in claim 3, wherein the step part is a first step part, and
wherein a second step part is formed on an inner surface of the edge of the first metal.

6. The secondary battery as recited in claim 5, wherein the secondary battery includes a first side terminal and a second side terminal, and
wherein one of the first side terminal and the second side terminal is coupled to the second step part.

7. The secondary battery as recited in claim 6, wherein an area of the first side plate or the second side plate coupled to the second step part comprises a chamfer region.

8. The secondary battery as recited in claim 7, wherein a diameter of the first side plate or a diameter of the second side plate is reduced by the chamfer region.

9. The secondary battery as recited in claim 3, wherein a protrusion is formed on the inner surface of the can,
wherein the protrusion supports a surface of the first side plate or a surface of the second side plate.

10. The secondary battery as recited in claim 9, wherein a groove corresponding to the protrusion is formed on an outer surface of the can.

11. The secondary battery as recited in claim 9, wherein the protrusion comprises a plurality of protrusions spaced apart from each other.

12. The secondary battery as recited in claim 1, wherein the can is formed in a pipe shape or in a bent plate shape.

13. The secondary battery as recited in claim 1, wherein a melting point of the second metal is greater than a melting point of the first metal.

14. The secondary battery as recited in claim 1, wherein the first metal and the second metal comprise different metals.

15. The secondary battery as recited in claim 10, wherein the groove is formed in the first metal.

16. The secondary battery as recited in claim 3, wherein an area of the second metal forming part of the outer surface of the can is greater than an area of the first metal forming part of the outer surface of the can.

17. The secondary battery as recited in claim 9, wherein an area of the first or second side plate coupled to the protrusion comprises a chamfer region.

18. The secondary battery as recited in claim 9, wherein the protrusion is formed at the edge of the first metal.

19. The secondary battery as recited in claim 3, wherein a thickness of the first side plate or the second side plate is less than a length of the edge of the first metal.

20. The secondary battery as recited in claim 1, wherein the can is formed by coupling two rectangular tubes.
